(19) United States
(12) Patent Application Publication
(10) Pub. No.: US 2018/0312371 A1
(43) Pub. Date: Nov. 1, 2018

(54) SUSPENSION ARRANGEMENT FOR AN ELEVATOR

(71) Applicant: Inventio AG, Hergiswil (CH)

(72) Inventor: Oliver Wuthrich, Wolhusen (CH)

(21) Appl. No.: 15/772,117

(22) PCT Filed: Nov. 4, 2016
(86) PCT No.: PCT/EP2016/076636

§ 371 Date: Apr. 30, 2018

(30) Foreign Application Priority Data
Nov. 6, 2015 (EP) 15193496.5

(51) Int. Cl. B66B 7/08; B66B 1/42; B66B 1/34; B66B 9/00

(52) U.S. Cl. CPC B66B 7/08; B66B 9/00; B66B 1/3492; B66B 1/42

(57) ABSTRACT

An actively controllable suspension arrangement positions a car in an elevator system, the car being suspended by a suspension traction apparatus and displaceable within an elevator shaft by a drive. The suspension arrangement includes a carrier assembly having at least one fixator attaching the suspension traction apparatus to the carrier assembly, a displacement assembly for displacing the carrier assembly a load direction of the car, a position determination assembly indicating a real position of the car, and a controller controlling operation of the displacement assembly based on measurement signals from the position determination assembly. The suspension arrangement can be used for actively controlling and influencing a positioning and/or a motion of the car in order to perform e.g. a fast re-leveling of the car during stops and/or to compensate unintended speed variations of the car resulting e.g. from a yo-yo effect, seismic effect or similar effects.

### FIELD

The present invention relates to a suspension arrangement for an elevator system and to an elevator system comprising such suspension arrangement.

### BACKGROUND

Elevator systems are typically applied for transporting persons or goods in buildings generally in a vertical direction. In a common elevator system type, an elevator car is suspended by suspension traction means such as belts or ropes. Therein, on the one hand, the suspension traction means carry a load of the elevator car and, on the other hand, may be used in order to displace the elevator car within an elevator shaft by displacing the suspension traction means in a controlled manner. For such displacing of the suspension traction means, the elevator system further comprises drive means comprising, inter alia, a motor driving a traction sheave into a rotating motion. The rotating traction sheave interacts with the suspension traction means thereby displacing the suspension traction means together with the car attached thereto within the elevator shaft.

Conventionally, there are generally two configurations for carrying and displacing the elevator car using the suspension traction means. In a first configuration, an end of the suspension traction means is mechanically held at a support means fixedly arranged within the elevator shaft and a portion of the suspension traction means is wound around one or more sheaves or pulleys mechanically connected to the elevator car. In a second configuration, the suspension traction means is wound around a traction sheave or pulley mechanically connected to a support means fixedly arranged within the elevator shaft and an end of the suspension traction means is mechanically connected to the elevator car. Therein, in both configurations, the mechanical connection between the end of the suspension traction means and the support means or the elevator car, respectively, may be a fixed and rigid connection. Alternatively, an elastic element such as a spring or an elastomeric damper may be included in such mechanical connections such that the suspension traction means is attached to the support means or the elevator car, respectively, with a certain degree of elasticity. Same may apply for the mechanical connection between the sheave/pulley and the elevator car or the support means, in both configurations, respectively.

In such conventional elevator systems, a positioning and travelling of the elevator car within the elevator shaft is generally controlled only by controlling the drive means driving the suspension traction means. In other words, by controlling a power supply to the motor of the drive means, the suspension traction means and the elevator car attached thereto may be displaced within the elevator shaft and may be travelled to intended positions.

However, it has been observed that an accuracy with which the elevator car may be positioned within the elevator shaft and/or a ride quality during travelling the elevator car along the elevator shaft may suffer under certain circumstances.

Accordingly, there may be a need for an elevator system in which a positioning accuracy for the elevator car and/or a ride quality during travel is improved.

### SUMMARY

According to a first aspect of the invention, a suspension arrangement for an elevator system is proposed. According to a second aspect of the invention, an elevator system comprising such suspension arrangement is proposed. Therein, the elevator system comprises an elevator car and suspension traction means mechanically connected to the elevator car such that the car is suspended by the suspension traction means in a load direction. Accordingly, the elevator car may be displaced within an elevator shaft upon controlled displacement of the suspension traction means in the load direction. The elevator system further comprises drive means for controlled displacing of the suspension traction means upon control of an elevator control. Furthermore, the elevator system comprises support means fixedly arranged within the elevator shaft. Specifically, the elevator system differs from conventional elevator systems due to the provision and specific configuration of the suspension arrangement comprised therein. This suspension arrangement comprises a carrier assembly, a displacement assembly, a position determination assembly and a controller. The carrier assembly comprises at least one fixator for attaching the suspension traction means to the carrier assembly. The displacement assembly is adapted and mechanically connected to the carrier assembly such as to induce displacing of the carrier assembly against the load direction. The position determination assembly is adapted for determining measurement signals indicating a real position of the elevator car within the elevator shaft. The controller is adapted for controlling operation of the displacement assembly. Specifically, the controller is adapted for controlling the displacement assembly based on the measurement signals from the position determination assembly. In the elevator system, the suspension arrangement may be arranged and adapted such that the elevator car is mechanically connected to the fix support means via the suspension traction means and the suspension arrangement.

Ideas underlying embodiments of the present invention may be interpreted as being based, inter alia and without restricting a scope of the invention, on the following observations and recognitions.

As indicated above, in conventional elevator systems, the suspension traction means are generally connected to fix support means within the elevator shaft, on the one hand, and to the elevator car, on the other hand, in a fixed or slightly elastic configuration. However, in all such fixation configurations, a fixation to the support means and to the elevator car is “passive” in the sense that a positioning of the suspension traction means on the one hand and the fixed support means or the elevator car, on the other hand, cannot be actively influenced or even regulated. Accordingly, in such conventional configurations, the position and the displacement of the elevator car within the elevator shaft may be controlled exclusively by suitably controlling the drive means displacing the suspension traction means using its motor and traction sheave.

However, as will be described further below with respect to specific examples, it has been found that a positioning accuracy and/or a ride quality of the elevator car may not be satisfying under certain conditions such as for example under load changes or other external influences to the elevator car.

It is therefore proposed to provide a suspension arrangement which may be interposed between the suspension traction means, on the one hand, and the elevator car or the fixed support means, respectively, to which the suspension traction means shall be attached. Therein, the suspension arrangement shall comprise a carrier assembly to which the suspension traction means may be attached using a specific fixator. Furthermore, the suspension arrangement comprises a displacement assembly which is adapted to displacing the carrier assembly together with the suspension traction means attached thereto in a direction against the load carried by the suspension traction means. In other words, the suspension arrangement comprises a carrier assembly and a displacement assembly which allow “actively” displacing the suspension traction means attached to the carrier assembly.

Particularly, in a configuration in which the suspension traction means is attached to a fix support means within an elevator shaft via the proposed suspension arrangement, a relative position between the suspension traction means and the support means may be actively controlled by suitably controlling the displacement assembly of the suspension arrangement. The displacement assembly then displaces the carrier assembly while for example a base of the displacement assembly being fixedly connected to the fix support means. Accordingly, in such configuration, the suspension arrangement allows specifically controlled displacement of the suspension traction means relative to the fixed support means.

In an alternative configuration, the suspension arrangement is interposed between the suspension traction means on the one side, and the elevator car, on the other side. Again, the suspension traction means is attached to the carrier assembly of the suspension arrangement via the at least one fixator. An opposite portion of the suspension arrangement such as a base of the displacement assembly may be attached to the elevator. Accordingly, in this configuration, a relative positioning between the suspension traction means and the elevator car may be actively controlled.

In both configurations, the elevator car is mechanically connected to the fixed support means via the suspension traction means and additionally via the interposed suspension arrangement. Accordingly, the suspension arrangement may be used in both configurations in order to actively displace the elevator car relative to the support means, i.e. to actively displace the elevator car within the elevator shaft. Therein, the displacement assembly of the suspension arrangement may be adapted such that such relative displacement may be performed quickly and/or with high positioning accuracy.

The additional option for relatively displacing the elevator car within the elevator shaft using the proposed suspension arrangement with its specific displacement assembly may then be used for e.g. enhancing a positioning accuracy with which the elevator car may be positioned within the elevator shaft or for enhancing a ride quality with which the elevator car may travel within the elevator shaft.

For enabling such functions, the suspension arrangement additionally comprises the position determination assembly. This position determination assembly is adapted for measuring a current real position of the elevator car within the elevator shaft and providing measurement signals accordingly.

Therein, the “real position of the elevator car” shall be the actual relative position of the elevator car within the elevator shaft. The position determination assembly shall generally be attached to the elevator car or be mechanically connected to the elevator car with a predetermined relative positioning thereto such that, by measuring its own position, the position determination assembly may provide measurement signals indicating the real position of the elevator car within the elevator shaft.

Accordingly, such real position measurements may differ from position indicating signals provided for example by the drive means of the elevator system. Such drive means conventionally track any displacement of the suspension traction means driven thereby and may therefore provide a certain degree of information regarding a current position of the elevator car attached to another end of the suspension traction means. However, for example due to variations in the length of the suspension traction means between the drive means and the elevator car, such position information provided by the drive means may lack accuracy and may differ from the actual real position of the elevator car within the elevator shaft.

Based on the measurement signals from the position determination assembly, the controller of the suspension arrangement may control the displacement assembly in order to suitably displace the carrier assembly. In other words, the proposed suspension arrangement may be used for actively regulating a relative positioning of the elevator car within the elevator shaft by taking into account the real position of the elevator car within the elevator shaft as indicated by the position determination assembly and then use this information in order to suitably actively displace the elevator car within the elevator shaft.

According to an embodiment, the controller of the suspension arrangement is adapted to receive control signals from the elevator control as well as the measurement signals from the position determination assembly. Therein, the control signals from the elevator control represent control commands to the drive means for an intended displacement of the car. The controller of the suspension arrangement may then be adapted for controlling the displacement assembly based on a comparison of the measurement signals from the position determination assembly with the control signals from the elevator control.

In other words, when controlling the displacement assembly of the suspension arrangement, the controller may take into account both, the measurement signals provided by the position determination assembly of the suspension arrangement as well as the control signals provided by the elevator control. Particularly, the controller may detect for example any differences between the real position of the elevator car as measured by the position determination assembly and any “virtual” or “calculated” position of the elevator car as derived from control signals of the elevator control. When such differences occur, this may mean that an intended displacement of the car as controlled by the drive means does not correctly correspond to a real displacement of the car and, correspondingly, a real positioning of the car within the elevator shaft does not correctly correspond to an intended positioning of the car. Thus, based on such detected differences, the controller of the suspension arrangement may suitably control the displacement assembly of the suspension arrangement in order to specifically control and change the relative positioning of the car in order to thereby for example bring the elevator car closer to its intended position.

In an example, the controller may for example detect that the real position of the elevator car within the elevator shaft suddenly tends to change although control signals from the elevator control are stationary, i.e. although the elevator control does not intend to displace the car within the elevator shaft. This may be the case, for example, when the elevator car is intentionally stopped at a floor such that passengers may enter or leave the elevator car. In such case when a heavy load suddenly enters or leaves the car, a lengthening of the suspension traction means carrying the car may change, thereby also changing the relative position of the car within the elevator shaft. Accordingly, in such situation, the control signals from the elevator control do not indicate any change in position of the car whereas the measurement signals of the position determination assembly indicating the real position of the elevator car indicate a tendency to a sudden de-positioning of the elevator car. Based on such detection, the controller of the suspension arrangement may specifically control the displacement assembly of the suspension arrangement to e.g. counteract such changes in car positioning. Preferably, the suspension arrangement and its controller are adapted to counteract very rapidly such that any tendency to a sudden de-positioning of the elevator car is quasi-immediately compensated.

According to another embodiment, the controller is adapted for controlling the displacement assembly based on a detection of an overspeed condition or of a periodically varying speed of the elevator car by analyzing the measurement signals from the position determination assembly.

In other words, the controller may for example continuously or periodically monitor the measurement signals provided by the position determination assembly in order to thereby monitor the real position of the elevator car and/or changes in such real position, i.e. a speed of the elevator car. When monitoring the speed of the elevator car, the controller may detect when such speed comes for example to a value where it exceeds an allowable maximum speed. Alternatively, by monitoring the car's speed, it may be determined when the elevator car changes its speed periodically. Both such situations are generally not intended and controlled by the elevator control but, instead, result from undesired influences onto the elevator car. For example, a temporary overspeed condition or a periodically varying speed of the elevator car may occur when a load onto the elevator car suddenly changes due to, for example, passengers bouncing within the elevator car. A periodically varying speed of the elevator car may also occur for example when the elevator car is suddenly accelerated or decelerated and the suspension traction means suspending the car periodically lengthens and shortens in reaction to a resulting load change. The latter effect is sometimes called yo-yo effect.

Such temporary overspeed or periodically varying speed may be partially or even completely compensated by suitably counteracting using the displacement assembly of the suspension arrangement proposed herein. In other words, when a temporary overspeed is detected, the suspension arrangement may induce some counteractions by suitably displacing the suspension traction means in a direction against the overspeed direction. Similarly, when detecting a periodically varying speed of the elevator car, the suspension arrangement may be applied for counteracting such “bouncing” by controlled counter-displacing the suspension traction means.

According to another embodiment of the invention, the controller is adapted for controlling the displacement assembly based on a comparison of the measured signals from the position determination assembly with predetermined reference signal patterns.

In other words, the controller may monitor the real position of the elevator car based on the measurement signals provided by the position determination assembly and may for example compare changes in such real position with predetermined motion patterns, i.e. compare the actual measurement signals with the predetermined reference signal patterns. The motion patterns may be acquired for example during a preceding calibration procedure in which a normal or intended behavior of the elevator car is examined under defined conditions. Alternatively, such motion patterns may be acquired as a result of simulations and/or calculations. Reference signal patterns corresponding to such motion patterns may then be stored for subsequent use. Accordingly, during subsequent operation of the elevator system, actual measurement signals may be compared with such predetermined reference signals and counter-measures may be initiated upon detection of any excessive deviations of the monitored measurement signals from the reference signal patterns by suitably controlling the suspension arrangement.

In specific embodiments, the controller may be adapted for performing specific functions during operation of the elevator system.

For example, according to an embodiment, the controller may be adapted for controlling the displacement assembly such as to achieve a re-levelling of the car when the car is held by the drive means and the traction suspension means in a stop position.

In other words, when the elevator control stops the drive means and thereby also stops the traction suspension means such that the elevator car is held in the stop position for example adjacent to a floor door of the elevator shaft, the proposed suspension arrangement may be used for re-levelling the car such that for example its bottom is substantially flush with the bottom of the neighboring floor.

Generally, the elevator control is configured such that it controls motions of the drive means specifically such that the car is precisely stopped at an intended stop position. However, due to for example passengers suddenly entering the car or leaving the car, a load onto the traction suspension means carrying the car may suddenly vary and a length of the traction suspension means may suddenly change. Such change generally results in a change of the position of the car such that the bottoms of the car and of the floor are no more flush to each other. As any steps between the car and the floor shall always be prevented, fast re-levelling may be beneficial. However, adjusting the position of the car using the drive means is typically too slow and may take in the order of a few seconds. Furthermore, regulations may rule that the drive means must not be activated during a stop of the car as long as the floor door is opened.

Accordingly, it may be beneficial to adapt and use the suspension arrangement described herein for re-levelling purposes. Therein, the real position of the elevator car may be monitored continuously or repeatedly and if any deviation from the intended stop position is detected, the displacement assembly of the suspension arrangement may be controlled suitably in order to counteract such deviation thereby achieving an intended re-levelling of the car.

In another embodiment, the controller is adapted for controlling the displacement assembly such as to counteract a periodical speed variation of the car. Such periodical speed variations may occur as a result of the above-mentioned yo-yo effect or as a result of so-called “torque ripples”, i.e. periodical stepwise torque variations occurring at the electric motor of the drive means upon turning at low rotation speeds. Furthermore, seismic activities resulting in agitating an entire building including its elevator system may result in periodical speed variations of the car.

All such speed variations may be counter-acted using the suspension arrangement proposed herein. Therein, it may be beneficially used that the displacement assembly may displace the carrier assembly with short reaction times and at high speeds such that any intrinsically or externally induced speed variation of the car may be compensated by controlling the suspension arrangement such as to generate for example an anti-cyclical movement. Thereby, any swinging, bouncing or even jerking action onto the elevator car may be compensated or at least reduced. As a result, a steady and smooth motion of the car during its travels may be obtained and ride quality for passengers in the car may be significantly enhanced.

According to an embodiment, the displacement assembly comprises a hydraulics, wherein a displaceable portion of the hydraulics is mechanically connected to the carrier assembly.

For example, such hydraulics may comprise one or more hydraulic cylinders which may be deployed and retracted. A fixed portion of the hydraulics may be fixedly connected for example with a base of the suspension arrangement whereas the displaceable portion of the hydraulics is fixed to the carrier assembly such that by deploying and retracting the hydraulics the carrier assembly is moved relative to the basis of the suspension arrangement, thereby indirectly displacing the elevator car suspended to the suspension traction means via the suspension arrangement.

Particularly, according to an embodiment, the displacement assembly may be adapted for displacing the carrier assembly within a range of at least 3 cm, preferably within a range of at least 5 cm and more preferably within a range of at least 10 cm.

Therein, a displacement range of the displacement assembly may be selected in dependence of characteristics of the elevator system in which the suspension arrangement is to be applied. For example, in an elevator system having a very long elevator shaft of e.g. 200 m, the required very long suspension traction means may be subject to substantial lengthening and shortening effects upon varying loads. For example, when a maximum allowable load is applied to the elevator car, lengthening of a long suspension traction means of more than 10 cm have been observed. When the displacement range of the displacement assembly is sufficiently large, such lengthening of the suspension traction means may be compensated using the suspension arrangement. Generally, it may be beneficial to provide the displacement assembly with a displacement range of more than 0.02%, preferably more than 0.05%, of the length of the elevator shaft of the elevator system. In case the displacement assembly comprises a hydraulics, a hydraulic cylinder, a piston and/or a reservoir for hydraulic fluid may be adapted such as to obtain such desired displacement range.

Furthermore, according to an embodiment, the displacement assembly may be adapted for displacing the carrier assembly with a velocity of at least 1 cm/s, preferably at least 5 cm/s or 10 cm/s. The faster the displacement assembly may move the carrier assembly, the better the suspension arrangement may compensate or counteract any undesired motions of the elevator car within the elevator shaft. In case the displacement assembly is provided with a hydraulics, such hydraulics may be specifically adapted for such rapid displacement actions by for example suitably dimensioning a pressurizing unit for pressurizing hydraulic fluid and/or suitably dimensioning components of the hydraulic system such as the cylinder, the piston, etc.

Furthermore, the displacement assembly should be suitably adapted for displacing the carrier assembly with a sufficient force to carry and displace the elevator car indirectly connected to the carrier assembly via the suspension traction means. For example, when the car is adapted to have a weight of 1000 kg, including its maximum payload, the displacement assembly may be adapted to generate displacing forces of more than 10 kN.

Furthermore, the displacement assembly should be adapted for displacing the carrier assembly with a suitable positioning accuracy of for example less than 1 cm, preferably less than 0.5 or 0.2 cm. Accordingly, using the suspension arrangement, for example any dangerous steps between the bottom of the elevator car and the bottom of an adjacent floor may be prevented by controllably compensating unintended motions of the elevator car.

According to an embodiment, the suspension arrangement is adapted for displacing the carrier assembly independent of any action of the drive means of the elevator system.

In other words, while the drive means is generally controlled by the elevator control, the displacement assembly in the suspension arrangement is generally controlled by the specific controller being part of the suspension arrangement and being preferably independent of the elevator control. Accordingly, while the elevator control typically controls the drive means in order to drive the elevator car to specific destinations as for example requested by passengers, the controller and displacement assembly in the suspension arrangement may be adapted to displace the carrier assembly independent of such “macroscopic” actions of the drive means in order to for example compensate “microscopic” deviations such as unintended de-levelling or unintended bouncing of the elevator car.

Therein, the displacement assembly may be for example actuated while the drive means is currently stopped, while the drive means is currently operated for continuously displacing the elevator car or while the drive means is currently accelerated or decelerated. In all such various operation modes of the drive means, the displacement assembly in the suspension arrangement may serve for specific functions such as re-levelling the car upon the drive means being currently stopped, absorbing torque ripples upon the drive means being slowly rotated or counteracting periodical speed variations during travelling of the car within the elevator shaft.

However, there may also be circumstances in which a communication between the suspension arrangement and the drive means or, more specifically, between the controller of the suspension arrangement and the elevator control, may be beneficial and/or in which it may be advantageous to displace the carrier assembly in dependence of an activity of the drive means.

For example, when the displacement assembly is provided with a hydraulic system and during operation of the suspension arrangement it is detected that the hydraulic system is close to a limit of its displacement range, it may be beneficial to correlate a controlled motion of the drive means with a controlled motion of the displacement assembly such as to rearrange the hydraulics towards for example a centered configuration while simultaneously compensating the motion of the displacement assembly by an adequate counter-motion of the drive means.

According to an embodiment, the suspension assembly is adapted for displacing the carrier assembly into a biased position depending on a determined current load status of the car.

In other words, a load status of the car may be measured using a load measuring device. Such load measuring device may be e.g. a pressure sensor integrated into a hydraulics forming part of the displacement assembly. Alternatively, the load status may be determined with other devices. Using the load measuring device, it may be e.g. determined whether the car is currently completely empty or completely occupied. Based on such information, the suspension arrangement, via its controller and its displacement assembly, may displace the carrier assembly into a biased position which is e.g. away from a centered position and which may be close to or at an extremum of a displacement range of the displacement assembly.

For example, when it is determined that the car is completely empty, it is evident that the weight of the car may only increase, for example when passengers enter the car. In such load status, the suspension arrangement may set the carrier assembly to a biased position towards its lower extremum such that, upon increase of the car's load, the carrier assembly may be moved upwards in order to compensate any lengthening of the suspension traction means resulting from the load increase.

Analogously, when full occupancy of the car is determined, the carrier assembly may be biased towards an upper extremum such that upon people exiting from the car any shortening of the suspension traction means resulting therefrom may be immediately compensated.

The biasing of the suspension means may be performed at various operation states of the elevator system such as for example during when the car is waiting at a floor, during when the car is travelling from one floor to another, etc.

According to an embodiment, the controller of the suspension arrangement comprises a control loop, i.e. a closed control loop or an open control loop, regulating the displacement arrangement at a frequency of at least 20 Hz, preferably at least 50 Hz or at least 100 Hz.

In other words, the controller monitors the real position of the elevator car based on the measurement signals from the position determination assembly and controls a motion to be performed by the displacement arrangement in dependence on such measured real position. Therein, a regulating feedback may be performed at the described frequency of at least 20 Hz such that the motion of the displacement arrangement may be quickly adapted. Due to such relatively high frequency in regulating the displacement arrangement, the suspension arrangement may quickly and precisely counteract unintended motions of the elevator car.

According to an embodiment, the position determination assembly comprises a sensor to be fixed at the elevator car and an indicator arrangement to be disposed along the elevator shaft, wherein the sensor and the indicator arrangement are adapted such that the sensor generates the measurement signals upon interaction with the indicator arrangement.

In other words, the position determination assembly may generally comprise two components. Therein, one component is a sensor and is attached to the elevator car such as to be displaced in the elevator shaft together with the elevator car. The other component is the indicator arrangement which may be kept stationary within the elevator shaft and may extend along the length or at least significant portions of the length of the elevator shaft. Accordingly, upon motion of the elevator car, the sensor is displaced relative to the indicator arrangement. When physical characteristics of the indicator arrangement vary along the extension direction of the indicator arrangement, such physical characteristics may be measured and may be taken as indicating the real position of the elevator car within the elevator shaft.

For example, the indicator arrangement may comprise a continuous substrate having multiple marks at various positions along an extension direction of the indicator arrangement.

These marks may have differing physical characteristics such that by measuring these characteristics using the sensor, the position determination assembly may acquire information about its current position. Alternatively, all marks may have the same physical characteristics but are arranged at predetermined distances to each other such that the sensor may detect when passing at one of the marks and may count the number of marks in order to thereby derive information about its current position. For example, the marks may be arranged at distances between each other of less than a desired positioning accuracy for the suspension arrangement, for example less than 2 cm, less than 1 cm or even less than 0.5 cm.

The sensor and the indicator arrangement of the position determination assembly may operate based on one of a variety of physical principles. For example, the sensor may be a magnetic sensor and the indicator arrangement may be a magnetic tape or foil being arranged along a sidewall of the elevator shaft and having a multiplicity of magnetic marks thereon, preferably at equidistant spacings. As an alternative, the sensor may be an optical sensor and the indicator arrangement may comprise an elongate substrate being arranged along the extension direction of the elevator shaft and having optically detectable marks thereon. Further alternatively, the position determination assembly may be implemented using a variety of other physical principles and correspondingly adapted sensors and indicator arrangements such as position determination based on electrical characteristics, other optical characteristics, other magnetic characteristics, acoustical characteristics, mechanical characteristics, etc.

In the elevator system proposed herein, the suspension arrangement according to one of the above described embodiments may be applied such that the elevator car is no more passively connected to a support means fixedly arranged within the elevator shaft but may be actively and controllably displaced by the suspension traction means being interposed somewhere between the elevator car and the fix support means, i.e. being either interposed between the elevator car and the suspension traction means or between the suspension traction means and the support means.

In a preferred embodiment, a fixed portion of the suspension arrangement is mechanically connected to the support means and a displaceable portion of the suspension arrangement is mechanically connected to the suspension traction means. In such specific arrangement, the suspension arrangement does not have to be moved together with the elevator car throughout the elevator shaft such that e.g. all power supply, supply of control signals and/or supply of any hydraulic fluid to hydraulics forming for example the displacement assembly may be simplified.

It shall be noted that possible features and advantages of embodiments of the invention are described herein partly with respect to a suspension arrangement and partly with respect to an elevator system comprising such suspension arrangement. One skilled in the art will recognize that the features may be suitably transferred from one embodiment to another and features may be modified, adapted, combined and/or replaced, etc. in order to come to further embodiments of the invention.

In the following, advantageous embodiments of the invention will be described with reference to the enclosed drawings. However, neither the drawings nor the description shall be interpreted as limiting the invention.

### DESCRIPTION OF THE DRAWINGS

FIG. 1 shows an elevator system comprising a suspension arrangement according to an embodiment of the invention.

FIG. 2 shows an enlarged perspective view of a suspension arrangement according to an embodiment of the invention.

The figures are only schematic and not to scale. Same reference signs refer to same or similar features throughout the figures.

### DETAILED DESCRIPTION

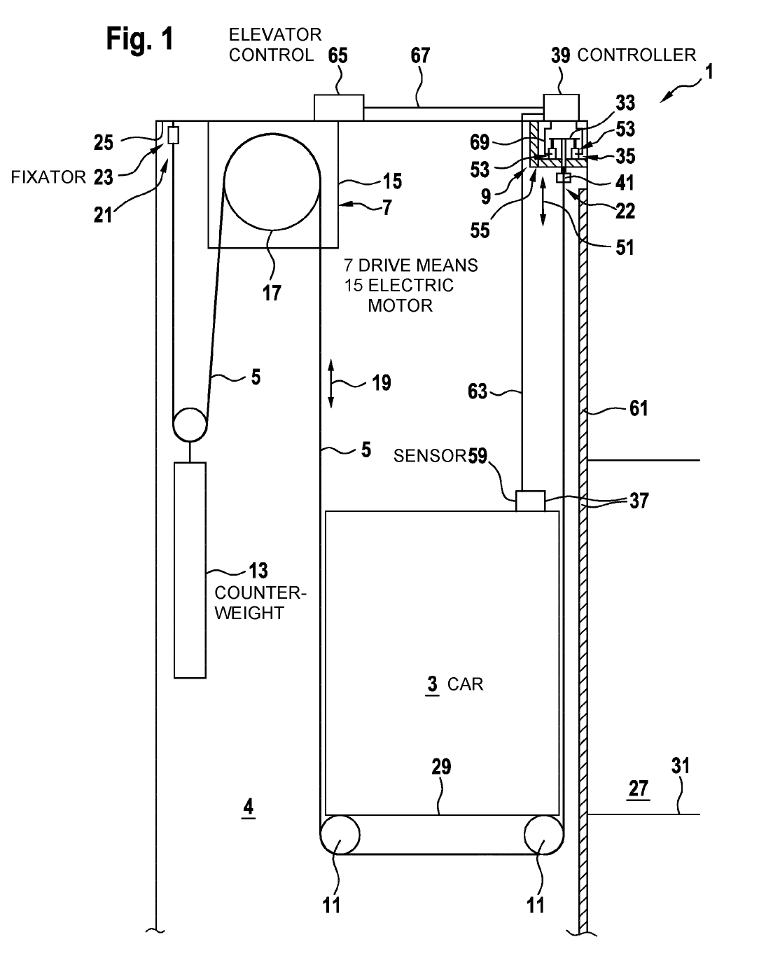

FIG. 1 shows an elevator system 1 according to an embodiment of the present invention. The elevator system 1 comprises an elevator car 3, suspension traction means 5, drive means 7 and a suspension arrangement 9.

The elevator car 3 is suspended by the suspension traction means 5. The suspension traction means 5 may comprise a plurality of belts or ropes which may carry the weight of the elevator car 3 and its payload in a load direction 51. In the example shown, the suspension traction means 5 engages support pulleys 11 fixed to a lower side of the elevator car 3 in a rotatable manner. Furthermore, the suspension traction means 5 also supports a counterweight 13.

The drive means 7 comprises an electric motor 15 driving a traction sheave 17 into rotating motion in order to thereby displace the suspension traction means 5 back and forth along a displacement direction 19 being substantially parallel to the load direction 51. Thereby, the elevator car 3 and the counterweight 13 may be displaced within an elevator shaft 4 in opposing vertical directions.

In the example shown in FIG. 1, one end 21 of the suspension traction means 5 is fixedly attached to a ceiling 25 of the elevator shaft 4 via a fixator 23. The fixator 23 may provide for a rigid fixed mechanical connection or a slightly elastic mechanical connection between the suspension traction means 5 and the ceiling 25 or any other fixed support means within the elevator shaft 4. However, such mechanical connection is passive in the sense that a positioning of the suspension traction means 5 with respect to the ceiling 25 of the elevator shaft 4 may not be actively influenced or varied.

In case, an opposite end 22 of the suspension traction means 5 would also be attached to the ceiling 25 with a similar mechanical connection, i.e. in a same passive manner, a positioning of the elevator car 3 within the elevator shaft 4 could only be influenced via specifically controlling the drive means 7.

However, in such conventional configuration, it has been observed that e.g. temporary length variations in the suspension traction means 5 occurring for example as a result of varying loads onto the elevator car 3 or as a result of external forces from the drive means 7, from bouncing passengers within the elevator car 3 or from e.g. seismic actions may lead to undesired motions of the elevator car 3.

For example, passengers quickly entering or leaving the elevator car 3 being stopped at one of the floors 27 may result in sudden changes in payload in the elevator car 3. Such weight variations may then induce an increase or decrease in length of the suspension traction means 5 which may result in a bottom 29 of the elevator car 3 being no longer flush with a bottom 31 of the floor 27 but instead forming an undesired step. Similarly, provoked force variations onto the elevator car 3 may result in a yo-yo effect during travelling of the elevator car 3.

Conventionally, attempts have been made to minimize such undesired effects. For example, a greater number of belts or ropes has been included into the suspension traction means 5 than would be necessary to carry the load of the elevator car 3 and the counterweight 13 in order to make the entire suspension stiffer. However, such additional components may add for example significant additional costs and/or weight to the elevator system 1.

Accordingly, in order to for example avoid such additional costs and/or provide for an increased security and/or increased ride quality at the elevator system 1, it is proposed to replace at least one of the passive mechanical connections of the suspension traction means 5 to a fixed structure within the elevator shaft 4 by an active suspension arrangement 9.

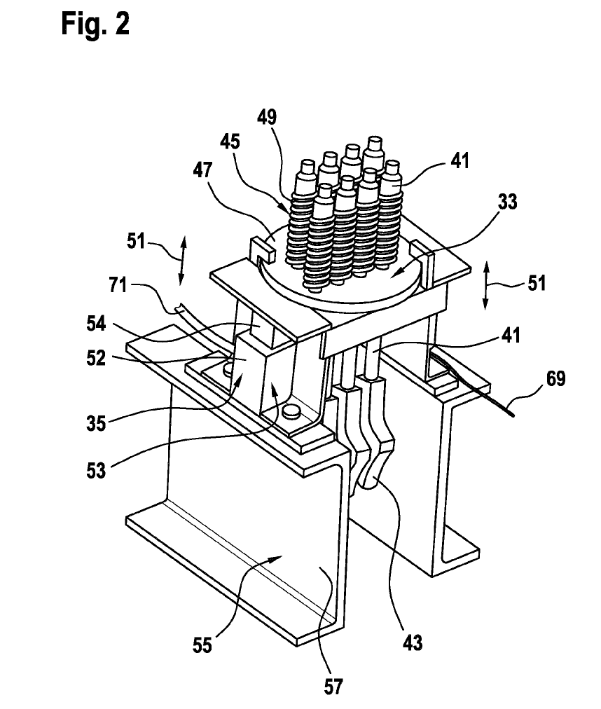

As very schematically shown in FIG. 1 and shown in FIG. 2 in an enlarged view of an exemplary embodiment, such suspension arrangement 9 comprises a carrier assembly 33, a displacement assembly 35, a position determination assembly 37 and a controller 39.

The carrier assembly 33 comprises fixators 41 to which the suspension traction means 5 may be attached. In the specific example shown in FIG. 2, eight fixators 41 are provided such that eight ropes (not shown in FIG. 2) may be attached to the carrier assembly 33. Therein, each fixator 41 comprises a first portion 43 fixedly connected with a respective one of the ropes or belts whereas a second portion 45 of the fixator 41 is mechanically held at a carrier plate 47 of the carrier assembly 33 via elastic means such as springs 49. Accordingly, any load held by the suspension traction means 5 in a load direction 51 may be elastically transmitted to the carrier plate 47 of the carrier assembly 33.

The displacement assembly 35 is provided with a hydraulics 53. In the example shown in FIG. 2, a lower part 52 of the hydraulics 53 is fixedly attached to a support means 55 such as a support beam 57 fixedly arranged within the elevator shaft 4. An upper part 54 of the hydraulics 53 may be displaced in a vertical direction with respect to the lower part 52 of the hydraulics 53 and is mechanically connected to the carrier assembly 33 such as to induce displacing of the carrier assembly's 33 carrier plate 47 together with its fixators 41 in directions parallel to the load direction 51.

The suspension arrangement 9 further comprises a sensor 59 and an indicator arrangement 61 forming part of the position determination assembly 37. The sensor 59 is attached to the elevator car 3 such as to be moved together with the elevator car 3 throughout the elevator shaft 4. The indicator arrangement 61 may be provided as elongate tape or ribbon attached to a sidewall of the elevator shaft 4 in an extension direction along the length of the elevator shaft 4.

Accordingly, using the sensor 59 and the indicator arrangement 61, the position determination assembly 37 may measure a real position of the elevator car 3 within the elevator shaft 4 and may provide corresponding measurement signals. Such measurement signals may be provided to the suspension arrangement's controller 39 e.g. via a signal line 63. This controller 39 may furthermore be connected to the drive means 7 or an elevator control 65 controlling this drive means 7 e.g. via a signal line 67. Furthermore, the controller 39 may be connected to the displacement assembly 35 in order to control its displacing action onto the carrier assembly 33. For example, the controller 39 may be connected via signal lines 69 to the hydraulics 53 such as to control a hydraulic fluid supply through hydraulic lines 71 to the hydraulics 53.

The controller 39 is adapted for controlling the displacement assembly 35 of the suspension arrangement 9 based on the measurement signals provided by the position determination assembly 37. Particularly, the controller 39 is adapted to receive such measurement signals together with the control signals from the elevator control 65 indicating an intended displacement of the car 3.

For example, based on a comparison of the control signals from the elevator control 65 with actual measurement signals from the position determination assembly 37, the controller 39 may determine whether an actual positioning of the elevator car 3 or an actual motion of the elevator car 3 is intended and is the result of an action of the drive means 7 controlled by the elevator control 65 or whether such positioning or motion is unintentional or exceeds an intentional motion. In the latter case, the controller 39 may activate the displacement assembly 35 of the suspension arrangement 9 such as to provoke displacing of the carrier assembly 33 together with the suspension traction means 5 fixed thereto in or against the load direction 51.

Accordingly, using the actively controllable suspension arrangement 9, actual information about the real position of the elevator car 3 within the elevator shaft 4 may be used for specifically counteracting against any unintended displacement or motion of the elevator car 3. Specifically, a displacement action of the displacement assembly 35 may be regulated depending, inter alia, on input signals comprising the measurement signals from the position determination assembly 37.

Embodiments of the suspension arrangement 9 and the elevator system 1 provided therewith may provide for a multiplicity of possible advantages. Particularly, various elevator functions may be improved using only one component, i.e. using the suspension arrangement 9.

For example, an excessively rigid suspension traction means 5 including more belts or ropes than actually needed for carrying the load of the car 3 and the counterweight 13 may be avoided as the actively controllable suspension arrangement 9 allows for actively compensating any lacking rigidity of the suspension traction means 5. Accordingly, costs for additional ropes or belts within the suspension traction means may be saved.

Furthermore, the suspension arrangement 9 may replace a car damping device otherwise provided for damping for example jerks onto the car 3.

Additionally, the suspension arrangement's ability for controllably generating a limited displacement of the elevator car 3 within the elevator shaft 4 may be advantageously used in case of an emergency braking action of the elevator car 3 in order to reduce or damp a maximum deceleration of the car 3.

Furthermore, torque ripples otherwise preferably occurring at low speeds and 1:1-suspension may be significantly damped using the suspension arrangement 9 (RQ-increase).

In areas of seismic activity, the suspension arrangement 9 may be used for damping or counteracting any undesired motions of the elevator car 3 due to seismic jerks.

Particularly in case the displacement assembly 35 is implemented with a hydraulic arrangement, additional elevator functions may be integrated into the suspension arrangement 9. For example, load measurement capabilities may be included by measuring a hydraulic pressure of a hydraulic fluid. Thus, other sensors conventionally provided for such purpose may be omitted. Furthermore, in a hydraulic system, unequal belt tensioning in the suspension traction means 5 may be avoided by implementing for example a fluid communication between various cylinders of a hydraulic system of the displacement assembly 35, each of a multiplicity of ropes or belts being mechanically connected to one of the hydraulic cylinders. Furthermore, no slack rope detectors may be necessary any more as one or more slacking ropes within a suspension traction means 5 generally result in a characteristic pressure variation which may unambiguously detected by the controller 39.

Finally, it should be noted that the term “comprising” does not exclude other elements or steps and the “a” or “an” does not exclude a plurality. Also elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A suspension arrangement for an elevator system, the elevator system including an elevator car suspended by a suspension traction means in a load direction and being displaceable within an elevator shaft upon controlled displacement of the suspension traction means, and a drive means for controlled displacing of the suspension traction means upon control by an elevator control of the elevator system, the suspension arrangement comprising:
a carrier assembly including at least one fixator attaching the suspension traction means to the carrier assembly;
a displacement assembly connected to the carrier assembly and operating to induce displacing of the carrier assembly parallel to the load direction;
a position determination assembly for generating measurement signals indicating a real position of the elevator car within the elevator shaft; and
a controller for controlling the operation of the displacement assembly, wherein the controller controls the operation of the displacement assembly in response to the measurement signals from the position determination assembly.

17. The suspension arrangement according to claim 16 wherein the controller receives control signals from the elevator control as well as the measurement signals from the position determination assembly, wherein the control signals from the elevator control represent control commands to the drive means for an intended displacement of the car, and wherein the controller controls the operation of the displacement assembly based on a comparison of the measurement signals from the position determination assembly with the control signals from the elevator control.

18. The suspension arrangement according to claim 16 wherein the controller controls the operation of the displacement assembly based on a detection of an overspeed or a periodically varying speed of the elevator car by analyzing the measurement signals from the position determination assembly.

19. The suspension arrangement according to claim 16 wherein the controller controls the operation of the displacement assembly based on a comparison of the measurement signals from the position determination assembly with predetermined reference signal patterns.

20. The suspension arrangement according to claim 16 wherein the controller controls the operation of the displacement assembly to re-level the elevator car when the elevator car is held by the drive means and the traction suspension means in a stop position.

21. The suspension arrangement according to claim 16 wherein the controller controls the operation of the displacement assembly to counteract a periodical speed variation of the elevator car.

22. The suspension arrangement according to claim 16 wherein the displacement assembly includes a hydraulics, and wherein a displaceable portion of the hydraulics is connected to the carrier assembly.

23. The suspension arrangement according to claim 16 wherein the displacement assembly is adapted to displace the carrier assembly parallel to the load direction by at least one of a distance of at least 3 cm and a velocity of at least 1 cm/s.

24. The suspension arrangement according to claim 16 wherein the suspension arrangement is adapted to displace the carrier assembly independent of any action of the drive means.

25. The suspension arrangement according to claim 16 wherein the suspension assembly is adapted to displace the carrier assembly into a biased position depending on a determined current load status of the elevator car.

26. The suspension arrangement according to claim 16 wherein the controller functions as a control loop regulating the operation of the displacement assembly at a frequency of at least 20 Hz.

27. The suspension arrangement according to claim 16 wherein the position determination assembly includes a sensor fixed at the elevator car and an indicator arrangement disposed along the elevator shaft, and wherein the sensor generates the measurement signals upon interaction with the indicator arrangement.

28. The suspension arrangement according to claim 27 wherein the indicator arrangement includes a continuous substrate having multiple marks at various positions along an extension direction of the indicator arrangement.

29. An elevator system including the suspension arrangement according to claim 16 comprising:
an elevator car;
a suspension traction means connected to the elevator car;
a drive means displacing the suspension traction means for displacing the elevator car within an elevator shaft by controlled displacement of the suspension traction means;
a support means fixedly arranged within the elevator shaft; and
wherein the elevator car is connected to the support means by the suspension traction means and the suspension arrangement.

30. The elevator system according to claim 29 wherein a fixed portion of the suspension arrangement is connected to the support means and a displaceable portion of the suspension arrangement is connected to the suspension traction means.
